(19) United States
(12) Patent Application Publication
(10) Pub. No.: US 2026/0095323 A1
(43) Pub. Date: Apr. 2, 2026

(54) PROCESSING APPARATUS, ACQUISITION METHOD, AND RECORDING MEDIUM

(71) Applicant: MegaChips Corporation, Osaka (JP)

(72) Inventor: Atsuro YOSHIDA, Osaka (JP)

(73) Assignee: MegaChips Corporation, Osaka (JP)

(21) Appl. No.: 19/337,972

(22) Filed: Sep. 24, 2025

(30) Foreign Application Priority Data
Oct. 2, 2024 (JP) 2024-173399

(51) Int. Cl. H04L 9/30

(52) U.S. Cl. CPC H04L 9/3066

(57) ABSTRACT

A processing apparatus includes an acquisition unit. The acquisition unit acquires a random point for use different from a point to be multiplied on an elliptic curve defined in a finite field, based on a plurality of first points known to be located on the elliptic curve, the random point for use being used to randomize the point to be multiplied in scalar multiplication processing of multiplying the point to be multiplied by a scalar multiplier.

### CROSS-REFERENCE TO RELATED APPLICATION

The present application claims priority of Japanese Patent Application No. 2024-173399, filed Oct. 2, 2024, the entire content of which are incorporated herein by reference in its entirety.

### BACKGROUND

### Technical Field

The present disclosure relates to a technology for acquiring a random point on an elliptic curve.

### Description of the Background Art

WO 2006/077651 discloses a technology for using a random point on an elliptic curve as a countermeasure against a side-channel attack in processing of multiplying a point on the elliptic curve by a scalar multiplier.

### SUMMARY

An aspect of a processing apparatus includes circuitry. The circuitry is configured to acquire a random point for use different from a point to be multiplied on an elliptic curve defined in a finite field, based on a plurality of first points known to be located on the elliptic curve, the random point for use being used to randomize the point to be multiplied in scalar multiplication processing of multiplying the point to be multiplied by a scalar multiplier.

An aspect of an acquisition method includes acquiring a random point for use different from a point to be multiplied on an elliptic curve defined in a finite field, based on a plurality of first points known to be located on the elliptic curve, the random point for use being used to randomize the point to be multiplied in scalar multiplication processing of multiplying the point to be multiplied by a scalar multiplier.

An aspect of a non-transitory computer-readable recording medium is configured to store a program to cause a computer apparatus to function as the circuitry included in the processing apparatus.

### BRIEF DESCRIPTION OF THE DRAWINGS

FIG. 1 is a schematic diagram illustrating an example of a configuration of a processing apparatus.

FIG. 2 is a schematic diagram illustrating an example of an algorithm of scalar multiplication processing.

FIG. 3 is a schematic diagram illustrating an example of a configuration of an acquisition unit.

FIG. 4 is a schematic diagram illustrating an example of a configuration of the acquisition unit.

FIG. 5 is a schematic diagram illustrating an example of a configuration of the acquisition unit.

FIG. 6 is a schematic diagram illustrating an example of a configuration of the acquisition unit.

FIG. 7 is a schematic diagram illustrating an example of a configuration of the acquisition unit.

FIG. 8 is a schematic diagram illustrating an example of a configuration of the acquisition unit.

FIG. 9 is a schematic diagram illustrating an example of a configuration of a system including the processing apparatus.

FIG. 10 is a schematic diagram illustrating an example of an operation of the system including the processing apparatus.

### DESCRIPTION OF THE PREFERRED EMBODIMENTS

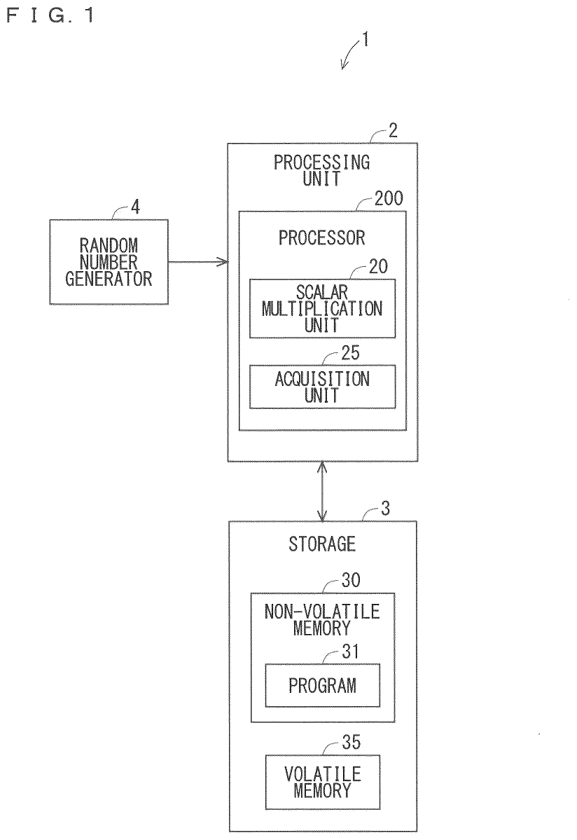

FIG. 1 is a schematic diagram illustrating an example of a configuration of a processing apparatus 1. The processing apparatus 1 can perform scalar multiplication processing of multiplying a point to be multiplied on an elliptic curve defined in a finite field used in elliptic curve cryptography by a scalar multiplier. The processing apparatus 1 can acquire a random point (also referred to as a random point for use or a random point for multiplication use) to be calculated with the point to be multiplied in the scalar multiplication processing. The point is also referred to as a rational point. For example, the point to be multiplied is also referred to a rational point to be multiplied, and the random point is also referred to as a random rational point.

As illustrated in FIG. 1, the processing apparatus 1 includes a processing unit 2, a storage 3, and a random number generator 4, for example. It can also be said that the processing apparatus 1 is a computer apparatus, for example. It can also be said that the processing apparatus 1 is a processing circuit, for example.

The random number generator 4 generates a random number. It can also be said that the random number generator 4 is a random number generating circuit, for example. The random number generator 4 generates a pseudorandom number using a hash function, for example. The random number generator 4 may generate a pseudorandom number from data specific to the processing apparatus 1 using a hash function, for example. The random number generator 4 inputs the generated random number to the processing unit 2. Each time the random number generator 4 outputs a random number, the random number generator 4 outputs a different random number, for example. Note that the random number generator 4 may generate a true random number.

The processing unit 2 includes at least one processor 200, for example. The at least one processor 200 included in the processing unit 2 may include a central processing unit (CPU), for example. It can also be said that the processing unit 2 is a processing circuit, for example.

The storage 3 includes a non-volatile memory 30 and a volatile memory 35, for example. It can also be said that the non-volatile memory 30 and the volatile memory 35 are each a non-transitory recording medium that can be read by the CPU of the processing unit 2. The non-volatile memory 30 may be a flash memory, for example. The non-volatile memory 30 may be a NAND flash memory, for example.

The volatile memory 35 functions as a working memory or the like when the processing unit 2 performs data processing. The volatile memory 35 may include a static RAM (SRAM), or may include a dynamic RAM (DRAM), for example. The RAM is an abbreviation for Random Access Memory.

The non-volatile memory 30 stores a program 31 and the like defining operations of the processing unit 2. Various functions of the processing unit 2 are implemented when the CPU of the processing unit 2 executes the program 31, for example.

Note that the configuration of the processing unit 2 is not limited to the above example. For example, the at least one processor 200 included in the processing unit 2 may include a plurality of CPUs, or may include at least one digital signal processor (DSP). All of the functions of the processing unit 2 or a part of the functions of the processing unit 2 may be implemented by a hardware circuit that does not require software for implementing its functions. The storage 3 may include a small-sized hard disk drive, a solid state drive (SSD), or the like.

The processing unit 2 includes, as its functional blocks, a scalar multiplication unit 20 and an acquisition unit 25, for example. The scalar multiplication unit 20 and the acquisition unit 25 are formed in the processing unit 2 when the CPU of the processing unit 2 executes the program 31. Note that all of the functions of the scalar multiplication unit 20 or a part of the functions of the scalar multiplication unit 20 may be implemented by a hardware circuit that does not require software for implementing its functions. The same applies to the acquisition unit 25.

The scalar multiplication unit 20 performs scalar multiplication processing of multiplying a point to be multiplied on an elliptic curve defined in a finite field by a scalar multiplier. The acquisition unit 25 acquires a random point for use to be used in the scalar multiplication processing.

The elliptic curve (also referred to as an elliptic curve for use) used in the processing apparatus 1 is expressed by (1) below, using an x-coordinate and a y-coordinate of an affine coordinate system, for example.

$$\begin{matrix}[ Expression 1 ] & \\ {y}^{2} ≡ {x}^{3} + ax + b mod p & ( 1 )\end{matrix}$$

The elliptic curve expressed by expression (1) is a Weierstrass curve defined in a finite field of characteristic p>3, points on the elliptic curve expressed by expression (1) are integer points.

The scalar multiplication unit 20 performs the scalar multiplication processing of multiplying a point P to be multiplied on the elliptic curve for use expressed in expression (1) by a scalar multiplier d (also referred to as a scalar value d). The scalar multiplier d is set to 1 or greater and less than the order of the point. The scalar multiplier d may be fixed, or may be variable. When being expressed as a binary number, the characteristic p is set to a value of several tens of bits to several hundreds of bits, for example. The scalar multiplier d is a random number, for example.

Multiplication of the point P to be multiplied by the scalar multiplier d is also referred to as scalar multiplication. The result of multiplication of the point P to be multiplied by the scalar multiplier d obtained in the scalar multiplication unit 20 is expressed as a scalar multiplication point dP. The scalar multiplication point dP is also referred to as scalar multiplication value.

In elliptic curve cryptography, key exchange, an electronic signature, or the like is performed using the scalar multiplier d as a private key and the scalar multiplication point dP as a public key. As the key exchange using an elliptic curve, ECDH is known. ECDH is an abbreviation for Elliptic Curve Diffie-Hellman key exchange. As the electronic signature using an elliptic curve, ECDSA is known. ECDSA is an abbreviation for Elliptic Curve Digital Signature Algorithm. In elliptic curve cryptography, a point referred to as a base point G serving as a starting point of encryption processing may be used as the point P to be multiplied, or a point other than the base point G may be used as the point P to be multiplied.

The processing apparatus 1 may perform key exchange with another apparatus using the scalar multiplier d and the scalar multiplication point dP. The processing apparatus 1 may perform an electronic signature using the scalar multiplier d and the scalar multiplication point dP. Note that the scalar multiplication point dP may be used by another apparatus, instead of the processing apparatus 1.

The acquisition unit 25 acquires a random point R for use to be used in a countermeasure against a side-channel attack in the scalar multiplication processing in the scalar multiplication unit 20. The random point R for use is a point different from the point P to be multiplied, and is used to randomize a point obtained in a process of the scalar multiplication processing to conceal a calculation process of the scalar multiplication processing. The scalar multiplication unit 20 performs the scalar multiplication processing using the random point R for use on the elliptic curve for use acquired in the acquisition unit 25. In the scalar multiplication processing, the point P to be multiplied is randomized, based on the random point R for use. This can reduce a probability that the scalar multiplier d to be kept secret is recovered due to a side-channel attack on the scalar multiplication processing. It can also be said that the random point R for use is a point for randomizing the point P to be multiplied.

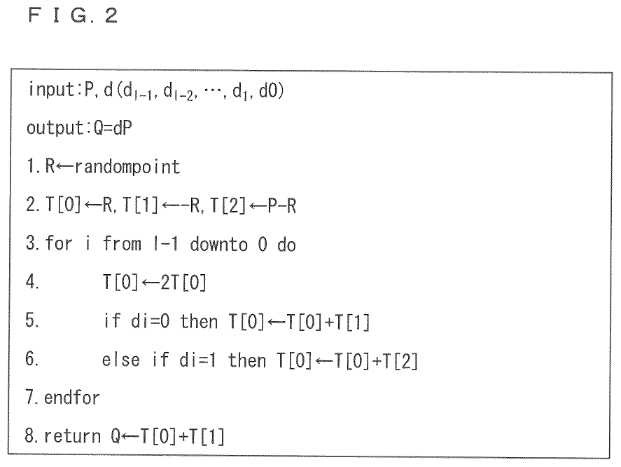

FIG. 2 is a schematic diagram illustrating an example of an algorithm of the scalar multiplication processing. The addition-chain algorithm illustrated in FIG. 2 is referred to as BRIP, and is one of the algorithms for performing the scalar multiplication processing resistant to a side-channel attack by using a random point. In the example of FIG. 2, the scalar multiplier d is expressed as a binary number of I bits (I is an integer of 1 or greater). A bit value of an i-bit (i is an integer of 0 or greater and (I−1) or less) from the bottom of the scalar multiplier d is expressed as dᵢ. The numbers 1 to 8 shown on the left side of FIG. 2 indicate execution step numbers.

In execution step 1, the scalar multiplication unit 20 receives the random point R for use from the acquisition unit 25. Next, in execution step 2, the scalar multiplication unit 20 sets parameters T[0], T[1], and T[2]. Specifically, the scalar multiplication unit 20 sets the random point R for use received from the acquisition unit 25 to the parameter T[0] as an initial value. The value (i.e., a point) of the parameter T[0] changes during execution of the scalar multiplication processing as needed. The scalar multiplication unit 20 sets an inverse element of the random point R for use to the parameter T[1]. It can also be said that the inverse element of the random point R for use is a random point. Then, the scalar multiplication unit 20 sets the result obtained by adding the point P to be multiplied and the inverse element of the random point R for use to the parameter T[2]. In other words, the scalar multiplication unit 20 sets the result obtained by subtracting the random point R for use from the point P to be multiplied to the parameter T[2]. It can also be said that the result obtained by adding the point P to be multiplied and the inverse element of the random point R for use is a random point. The values (i.e., points) of the parameters T[1] and T[2] are fixed.

Addition of two points in the scalar multiplication processing is performed through calculation in the finite field in which coordinates of the two points are used. As a result of addition of the two points, coordinates of a new point obtained by the addition of the two points is obtained.

After setting the parameters T[0], T[1], and T[2], the scalar multiplication unit 20 acquires the bit value dᵢ of the scalar multiplier d expressed as a binary number one bit at a time from the most significant bit to the least significant bit, and each time the scalar multiplication unit 20 acquires the bit value dᵢ, the scalar multiplication unit 20 executes the calculation processing including execution steps 4 to 6. Through the calculation processing including execution steps 4 to 6, the point P to be multiplied is randomized based on the random point R for use.

In execution step 4, the scalar multiplication unit 20 newly sets, to the parameter T[0], a result obtained by doubling the point currently set to the parameter T[0]. After execution step 4, when the acquired bit value dᵢ is 0, in execution step 5, the scalar multiplication unit 20 newly sets, to the parameter T[0], a result obtained by adding the point currently set to the parameter T[0] and the point (−R) set to the parameter T[1]. On the other hand, when the acquired bit value dᵢ is 1, in execution step 6, the scalar multiplication unit 20 newly sets, to the parameter T[0], a result obtained by adding the point currently set to the parameter T[0] and the point (P−R) set to the parameter T[2].

When the scalar multiplication unit 20 executes the calculation processing including execution steps 4 to 6 on each bit value dᵢ of the I bits of the scalar multiplier d, (dP+R) is set to the parameter T[0]. In execution step 8, the scalar multiplication unit 20 adds the point (dP+R) set to the parameter T[0] and the point (−R) set to the parameter T[1], so that the scalar multiplication unit 20 acquires the scalar multiplication point dP.

As can be understand from the above description, in the scalar multiplication processing, regardless of whether the bit value dᵢ is 0 or 1, addition processing (i.e., doubling) of the point of the parameter T[0] and the point of the parameter T[0] and addition processing of the point of the parameter T[0] and another point are performed. This reduces a difference between power consumption of the processing unit 2 when the bit value dᵢ is 0 and power consumption of the processing unit 2 when the bit value dᵢ is 1. This results in a reduction of a probability that the scalar multiplier d to be kept secret is recovered due to a simple power analysis (SPA) attack, which is a type of side-channel attack.

Furthermore, in the scalar multiplication processing, the variable parameter T[0] is always affected by the random point R, and the random point is always set to the parameter T[0]. Accordingly, the point obtained during the scalar multiplication processing is always a random point. This results in a reduction of a probability that the scalar multiplier d to be kept secret is recovered due to a differential power analysis (DPA) attack, which is a type of side-channel attack.

Note that the elliptic curve for use may be a Montgomery curve, may be a twisted Edwards curve, or may be another elliptic curve.

### <Configuration Example of Acquisition Unit>

The acquisition unit 25 acquires the random point R for use different from the point P to be multiplied, based on a plurality of points known to be located on the elliptic curve for use. For example, the acquisition unit 25 acquires the random point R for use different from the point P to be multiplied, based on points S1 and S2 known to be located on the elliptic curve for use. In the following, the points known to be located on the elliptic curve for use may each be referred to as a known point.

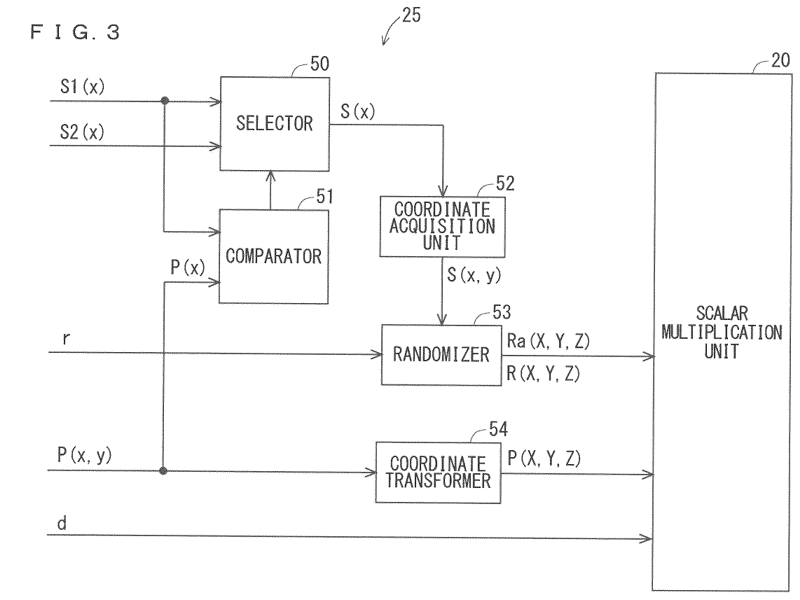

FIG. 3 is a schematic diagram illustrating an example of a configuration of the acquisition unit 25. As illustrated in FIG. 3, the acquisition unit 25 includes a selector 50, a comparator 51, a coordinate acquisition unit 52, a randomizer 53, and a coordinate transformer 54, for example.

To the acquisition unit 25, the scalar multiplier d and affine coordinates P (x, y) of the point P to be multiplied are input. The coordinate transformer 54 transforms the affine coordinates P (x, y) of the point P to be multiplied into projective coordinates P (X, Y, Z). In this case, the Z-coordinate of the projective coordinates P (X, Y, Z) may be set to 1, or may be set to another value, for example. In the present example, the affine coordinates are expressed using an x-coordinate and a y-coordinate in lowercase, and the projective coordinates are expressed using an X-coordinate, a Y-coordinate, and a Z-coordinate in uppercase. In the present example, the projective coordinate system used in the processing unit 2 employs projective coordinates, but may employ Jacobian coordinates. In this case, the coordinate transformer 54 transforms the affine coordinates P (x, y) of the point P to be multiplied into Jacobian coordinates.

The projective coordinates P (X, Y, Z) of the point P to be multiplied obtained in the coordinate transformer 54 are input to the scalar multiplication unit 20. The scalar multiplication unit 20 performs the scalar multiplication processing using the projective coordinates P (X, Y, Z) of the point P to be multiplied.

The selector 50 selects any one of the known points S1 and S2, based on the comparison result in the comparator 51. To the selector 50, for example, an x-coordinate S1 (x) of an affine coordinate of the known point S1 and an x-coordinate S2 (x) of an affine coordinate of the known point S2 are input. The x-coordinates S1 (x) and S2 (x) are stored in the non-volatile memory 30 in advance, for example. The selector 50 selects any one of the x-coordinates S1 (x) and S2 (x) based on the comparison result in the comparator 51, and thereby selects any one of the known points S1 and S2. When the x-coordinate S1 (x) is selected, the known point S1 is selected, and when the x-coordinate S2 (x) is selected, the known point S2 is selected.

The known point S1 is a point having the smallest x-coordinate out of a finite number of points (i.e., integer points) on the elliptic curve for use defined in the finite field, for example. Thus, the x-coordinate S1 (x) of the known point S1 is the smallest x-coordinate out of the x-coordinates of the finite number of points on the elliptic curve for use.

The known point S2 is a point having the second smallest x-coordinate out of the finite number of points on the elliptic curve for use, for example. Thus, the x-coordinate S2 (x) of the known point S2 is the second smallest x-coordinate out of the x-coordinates of the finite number of points on the elliptic curve for use,

The comparator 51 compares the x-coordinate S1 (x) of an affine coordinate of the known point S1 and the x-coordinate P (x) of the affine coordinates P (x, y) of the point P to be multiplied, and determines whether or not the both match, for example. When the comparator 51 determines that the x-coordinate S1 (x) of the known point S1 and the x-coordinate P (x) of the point P to be multiplied do not match, the selector 50 selects the x-coordinate S1 (x) and thereby selects the known point S1. In this case, the selected known point S1 is different from the point P to be multiplied. On the other hand, when the comparator 51 determines that the x-coordinate S1 (x) of the known point S1 and the x-coordinate P (x) of the point P to be multiplied match, the selector 50 selects the x-coordinate S2 (x) and thereby selects the known point S2. In this case, the selected known point S2 is different from the point P to be multiplied.

In the following, the x-coordinate selected by the selector 50 out of the x-coordinate S1 (x) and the x-coordinate S2 (x) is referred to as a selected x-coordinate S (x). The selected x-coordinate S (x) is different from the x-coordinate P (x) of the point P to be multiplied. The known point selected by the selector 50 out of the known point S1 and the known point S2 is referred to as a selected known point S. The selected known point S is different from the point P to be multiplied.

It can also be said that a block including the selector 50 and the comparator 51 selects a known point different from the point P to be multiplied out of a plurality of known points. The selected known point is the selected known point S. The block including the selector 50 and the comparator 51 compares a coordinate (in the above example, an x-coordinate) of the known point S1 on one axis and a coordinate of the point P to be multiplied on the one axis, and when both the coordinates are different, selects the known point S1 as the known point different from the point P to be multiplied. When a coordinate of the known point S1 on one axis and a coordinate of the point P to be multiplied on the one axis match, the block including the selector 50 and the comparator 51 selects the known point S2 different from the known point S1 as the known point different from the point P to be multiplied.

The coordinate acquisition unit 52 acquires affine coordinates S (x, y) of the selected known point S (the known point S1 or the known point S2) using the selected x-coordinate S (x) and expression (1) described above. Specifically, the coordinate acquisition unit 52 substitutes the selected x-coordinate S (x) for the variable x in expression (1), and obtains a y-coordinate to be paired with the selected x-coordinate S (x). Because the y-coordinate to be paired with the selected x-coordinate S (x) is a y-coordinate of the affine coordinates S (x, y) of the selected known point S, the affine coordinates S (x, y) of the selected known point S are acquired.

Note that the comparator 51 may compare the x-coordinate S2 (x) and the x-coordinate P (x). In this case, when the comparator 51 determines that the x-coordinate S2 (x) and the x-coordinate P (x) do not match, the selector 50 selects the x-coordinate S2 (x) and thereby selects the known point S2. On the other hand, when the comparator 51 determines that the x-coordinate S2 (x) and the x-coordinate P (x) match, the selector 50 selects the x-coordinate S1 (x) and thereby selects the known point S1.

The randomizer 53 randomizes the coordinates of the selected known point S based on a random number r generated in the random number generator 4, and acquires a first random point Ra to be used as the random point R for multiplication use. It can also be said that the randomizer 53 acquires the first random point Ra, based on the random number r and the selected known point S. In the present example, the random number r is an integer of 1 or greater and (p−1) or less.

The randomizer 53 transforms the affine coordinates S (x, y) of the selected known point S into projective coordinates S (X, Y, Z). In this case, the randomizer 53 generates the projective coordinates S (X, Y, Z), with the Z-coordinate being the random number r. The projective coordinates with the Z-coordinate being set to the random number r are referred to as randomized projective coordinates. The X-coordinate and the Y-coordinate of the randomized projective coordinates are random numbers, based on the random number r (Z-coordinate). The processing of transforming the affine coordinates into the randomized projective coordinates is also referred to as randomized projective transformation, for example.

In the present example, the selected known point S having the randomized projective coordinates S (X, Y, Z), i.e., the selected known point S expressed by the randomized projective coordinates S (X, Y, Z), is the first random point Ra. Because the first random point Ra is used as the random point R for use, the selected known point S expressed by the randomized projective coordinates S (X, Y, Z) is the random point R for use. It can also be said that the randomizer 53 acquires the first random point Ra expressed by projective coordinates, based on the random number r and the selected known point S expressed by affine coordinates. The first random point Ra can be obtained by randomizing the coordinate expression of the selected known point S.

The projective coordinates Ra (X, Y, Z) of the first random point Ra (i.e., the randomized projective coordinates S (X, Y, Z)) acquired in the randomizer 53 are input to the scalar multiplication unit 20 as the projective coordinates R (X, Y, Z) of the random point R for use. The scalar multiplication unit 20 performs the scalar multiplication processing using the projective coordinates P (X, Y, Z) of the point P to be multiplied and the projective coordinates R (X, Y, Z) of the random point R for use. The scalar multiplication unit 20 performs the scalar multiplication processing using the point expressed by projective coordinates.

The scalar multiplication unit 20 executes the scalar multiplication processing a plurality of times, for example. At least one of the point P to be multiplied and the scalar multiplier d changes each time the scalar multiplication processing is performed. The acquisition unit 25 acquires a different first random point Ra for each scalar multiplication processing. In the randomizer 53, a different random number r is used for each scalar multiplication processing. This allows the scalar multiplication unit 20 to use a different random point R for use, each time the scalar multiplication unit 20 performs the scalar multiplication processing. This results in a reduction of a probability that the scalar multiplier d is recovered due to a side-channel attack.

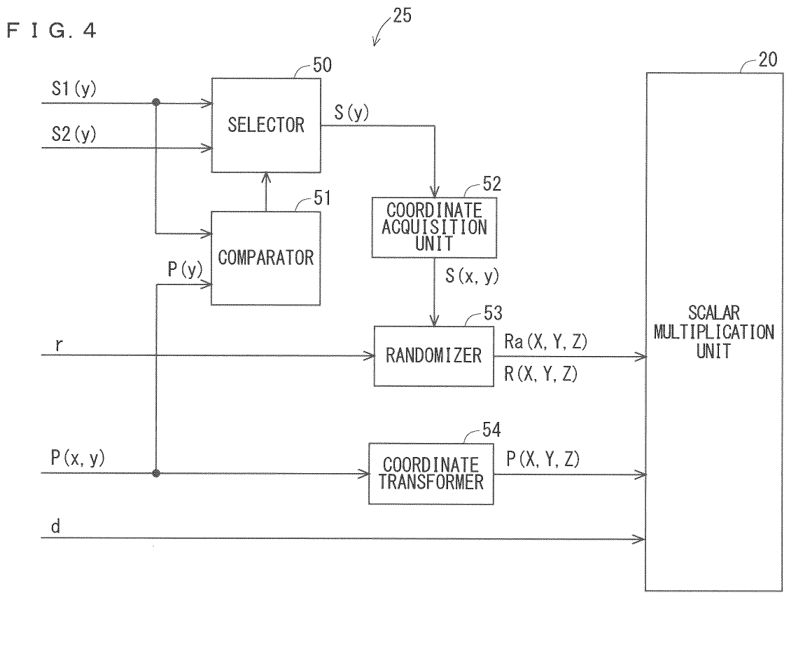

Note that, as illustrated in FIG. 4, to the selector 50, a y-coordinate S1 (y) of an affine coordinate of the known point S1 and a y-coordinate S2 (y) of an affine coordinate of the known point S2 may be input. In this case, the selector 50 selects any one of the y-coordinates S1 (y) and S2 (y), and thereby selects any one of the known points S1 and S2. The y-coordinates S1 (y) and S2 (y) are stored in the non-volatile memory 30 in advance.

In the example of FIG. 4, the known point S1 may be a point having the smallest y-coordinate out of a finite number of points on the elliptic curve for use defined in the finite field, for example. In this case, the y-coordinate S1 (y) of the known point S1 is the smallest y-coordinate out of the y-coordinates of the finite number of points on the elliptic curve for use. The known point S2 may be a point having the second smallest y-coordinate out of the finite number of points on the elliptic curve for use. In this case, the y-coordinate S2 (y) of the known point S2 is the second smallest y-coordinate out of the y-coordinates of the finite number of points on the elliptic curve for use.

In the example of FIG. 4, the comparator 51 compares the y-coordinate S1 (y) and the y-coordinate P (y) of the affine coordinates P (x, y) of the point P to be multiplied, for example. When the comparator 51 determines that the y-coordinate S1 (y) and the y-coordinate P (y) do not match, the selector 50 selects the y-coordinate S1 (y) and thereby selects the known point S1. On the other hand, when the comparator 51 determines that the y-coordinate S1 (y) and the y-coordinate P (y) match, the selector 50 selects the y-coordinate S2 (y) and thereby selects the known point S2. The coordinate acquisition unit 52 substitutes the selected y-coordinate S (y) selected in the selector 50 out of the y-coordinate S1 (y) and the y-coordinate S2 (y) for the variable y in expression (1), and acquires the affine coordinates S (x, y) of the selected known point S.

In the example of FIG. 4, the comparator 51 may compare the y-coordinate S2 (y) and the y-coordinate P (y) of the point P to be multiplied. In this case, when the comparator 51 determines that the y-coordinate S2 (y) and the y-coordinate P (y) do not match, the selector 50 selects the y-coordinate S2 (y) and thereby selects the known point S2. On the other hand, when the comparator 51 determines that the y-coordinate S2 (y) and the y-coordinate P (y) match, the selector 50 selects the y-coordinate S1 (y) and thereby selects the known point S1.

As described above, in the present example, the acquisition unit 25 acquires the random point R for use different from the point P to be multiplied, based on a plurality of points known to be located on the elliptic curve for use.

Here, when the random point R for use matches the point P to be multiplied, a point at infinity is set to the parameter T[2] used in the scalar multiplication processing. In this case, the scalar multiplication point dP cannot be appropriately obtained in the scalar multiplication processing.

In the present example, because the random point R for use is different from the point P to be multiplied, setting of a point at infinity to the parameter T[2] can be avoided. Consequently, an appropriate random point R for use is acquired, and the scalar multiplication point dP can be appropriately obtained in the scalar multiplication processing.

Because the random point R for use is acquired based on a plurality of points known to be located on the elliptic curve for use, the random point R for use can be acquired in a short processing time. For example, when the y-coordinate is to be obtained using expression (1) with the x-coordinate being set to a random number in order to acquire the random point R for use, the y-coordinate to be paired with the set x-coordinate may not be obtained. In other words, there may not be a point having the set x-coordinate on the elliptic curve. In this case, it may be necessary that setting of the x-coordinate and calculation of the y-coordinate be performed repeatedly. In contrast, in the present example, because the random point R for use is acquired based on a plurality of points known to be located on the elliptic curve for use, the random point R for use can be acquired for a short processing time, without occurrence of such repeated processing.

In the present example, because the random point R for use is acquired based on the known point different from the point P to be multiplied, the random point R for use different from the point P to be multiplied can be simply acquired. Because the random point R for use is acquired based on a plurality of points known to be located on the elliptic curve for use, the random point R for use different from the point P to be multiplied can be simply acquired.

In the present example, the acquisition unit 25 compares a coordinate (an x-coordinate or a y-coordinate) of the known point on one axis and a coordinate of the point P to be multiplied on the one axis, and when both the coordinates are different, selects the known point as the known point different from the point P to be multiplied. In this manner, when the known point different from the point P to be multiplied is selected through comparison between coordinates on one axis, the processing of selecting the known point different from the point P to be multiplied can be simplified.

In the present example, when a coordinate of the known point on one axis and a coordinate of the point P to be multiplied on the one axis match, the acquisition unit 25 selects a known point different from the known point as the known point different from the point P to be multiplied. This eliminates the need for coordinate comparison when a coordinate of the known point on one axis and a coordinate of the point P to be multiplied on the one axis match, and can simplify the processing of selecting the known point different from the point P to be multiplied.

In the present example, out of the finite number of points on the elliptic curve for use defined in the finite field, the point S1 having the smallest coordinate on one axis (an x-coordinate or a y-coordinate) and the point S2 having the second smallest coordinate on the one axis are used. This can reduce a storage area for coordinates of the known points S1 and S2 on one axis in the non-volatile memory 30. Note that the known point used in acquisition of the random point R for use is not limited to this.

The scalar multiplication unit 20 may acquire the affine coordinates S (x, y) of the selected known point S based on the selected x-coordinate S (x) or the selected y-coordinate S (y) using a calculation function used in the scalar multiplication processing. In this case, the scalar multiplication unit 20 functions as the coordinate acquisition unit 52. The affine coordinates of the known points S1 and S2 may be stored in the non-volatile memory 30 in advance. In this case, the coordinate acquisition unit 52 may read the y-coordinate to be paired with the selected x-coordinate S (x) or the x-coordinate to be paired with the selected y-coordinate S (y) from the non-volatile memory 30, and acquire the affine coordinates S (x, y) of the selected known point S. In this case, calculation using expression (1) in the coordinate acquisition unit 52 is unnecessary.

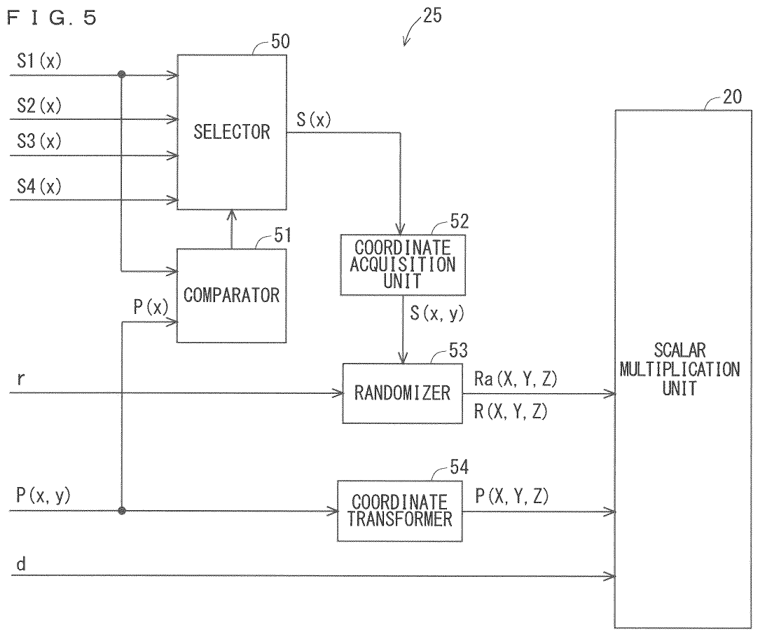

The acquisition unit 25 may select the known point different from the point P to be multiplied out of three or more known points. FIG. 5 is a schematic diagram illustrating an example of a configuration of the acquisition unit 25 in such a case. In the example of FIG. 5, to the selector 50, the x-coordinate S1 (x) of the known point S1, the x-coordinate S2 (x) of the known point S2, an x-coordinate S3 (x) of a known point S3, and an x-coordinate S4 (x) of a known point S4 are input. The x-coordinates S1 (x), S2 (x), S3 (x), and S4 (x) are stored in the non-volatile memory 30 in advance. The comparator 51 compares the x-coordinate S1 (x) of the known point S1 and the x-coordinate P (x) of the point P to be multiplied, for example. When the comparator 51 determines that both the coordinates are different, the selector 50 selects the x-coordinate S1 (x) and thereby selects the known point S1. On the other hand, when the comparator 51 determines that both the coordinates match, the selector 50 selects an x-coordinate different from the x-coordinate S1 (x) out of the x-coordinates S2 (x), S3 (x), and S4 (x), and thereby selects a known point different from the known point S1 out of the known points S1, S2, and S3. In other words, the selector 50 selects any one of the known points S2, S3, and S4. For example, each time it is determined that the x-coordinate S1 (x) and the x-coordinate P (x) match, the selector 50 may sequentially select one of the known points S2, S3, and S4.

### <Other Configuration Examples of Acquisition Unit>

### First Other Example

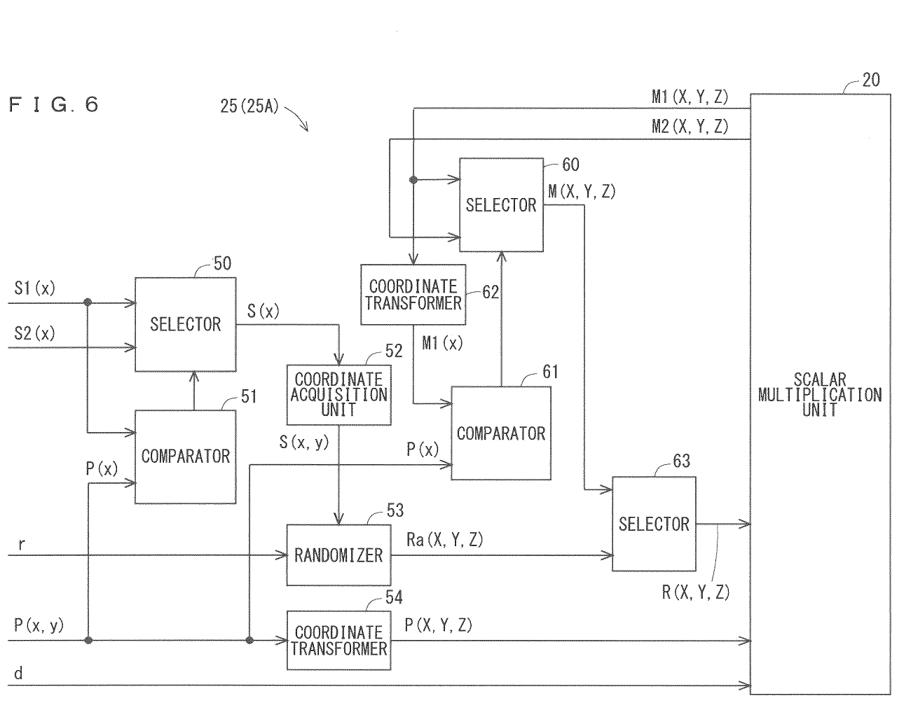

FIG. 6 is a schematic diagram illustrating another configuration example of the acquisition unit 25. The acquisition unit 25 (also referred to as an acquisition unit 25A) illustrated in FIG. 6 is different from the acquisition unit 25 illustrated in FIG. 3 in further provision of a selector 60, a comparator 61, a coordinate transformer 62, and a selector 63. The acquisition unit 25A acquires the random point R for use, based on a plurality of points obtained during the scalar multiplication processing in the scalar multiplication unit 20 and a plurality of known points. In the following, the points obtained during the scalar multiplication processing may each be referred to as an interim result point.

For example, similarly to the acquisition unit 25 described above, the acquisition unit 25A acquires the first random point Ra, based on a plurality of known points. Then, the acquisition unit 25A acquires the random point R for use, based on the first random point Ra and a plurality of interim result points. For example, the acquisition unit 25A selects an interim result point different from the point P to be multiplied out of the plurality of interim result points obtained during the scalar multiplication processing. Then, the acquisition unit 25A uses any one of the interim result point different from the point to be multiplied and the first random point Ra as the random point R for use to be used in the next scalar multiplication processing.

The selector 60 selects any one of a plurality of different interim result points, based on the comparison result in the comparator 61. To the selector 60, projective coordinates of a plurality of interim result points are input. The selector 60 selects any one of the projective coordinates of the plurality of interim result points, and thereby selects any one of the plurality of interim result points.

To the selector 60, for example, projective coordinates M1 (X, Y, Z) of an interim result point M1 and projective coordinates M2 (X, Y, Z) of an interim result point M2 different from the interim result point M1 are input. The projective coordinates M1 (X, Y, Z) and M2 (X, Y, Z) are obtained during the scalar multiplication processing.

The interim result points M1 and M2 may be points set to the parameter T[0] during the scalar multiplication processing. The interim result point M1 may be a point set to the parameter T[0] immediately before the end of the scalar multiplication processing, for example. In this case, the interim result point M1 is represented by (dP+R). The interim result point M2 may be a point different from (dP+R) set to the parameter T[0] during the scalar multiplication processing, for example. Because the point set to the parameter T[0] is a random point, the interim result points M1 and M2 are random points.

The selector 60 selects any one of the projective coordinates M1 (X, Y, Z) of the interim result point M1 and the projective coordinates M2 (X, Y, Z) of the interim result point M2, based on the comparison result in the comparator 61. When the projective coordinates M1 (X, Y, Z) are selected, the interim result point M1 is selected, and when the projective coordinates M2 (X, Y, Z) are selected, the interim result point M2 is selected.

The coordinate transformer 62 transforms the projective coordinates M1 (X, Y, Z) of the interim result point M1 into affine coordinates M1 (x, y), for example. The comparator 61 compares the x-coordinate M1 (x) of the affine coordinates M1 (x, y) obtained in the coordinate transformer 62 and the x-coordinate P (x) of the point P to be multiplied, and determines whether or not the both match.

When the comparator 61 determines that the x-coordinate M1 (x) of the interim result point M1 and the x-coordinate P (x) of the point P to be multiplied do not match, the selector 60 selects the projective coordinates M1 (X, Y, Z) and thereby selects the interim result point M1. In this case, the selected interim result point M1 is different from the point P to be multiplied. On the other hand, when the comparator 61 determines that the x-coordinate M1 (x) of the interim result point M1 and the x-coordinate P (x) of the point P to be multiplied match, the selector 60 selects the projective coordinates M2 (X, Y, Z) and thereby selects the interim result point M2. In this case, the selected interim result point M2 is different from the point P to be multiplied.

In the following, the projective coordinates selected by the selector 60 out of the projective coordinates M1 (X, Y, Z) and the projective coordinates M2 (X, Y, Z) are referred to as selected projective coordinates M (X, Y, Z). The interim result point selected by the selector 60 out of the interim result points M1 and M2 is referred to as a selected interim result point M. The selected interim result point M is different from the point P to be multiplied.

The selector 63 selects any one of the selected interim result point M and the first random point Ra obtained in the randomizer 53 as the random point R for use. To the selector 63, the projective coordinates M (X, Y, Z) of the selected interim result point M and the projective coordinates R (X, Y, Z) of the first random point Ra are input. The selector 63 selects the projective coordinates M (X, Y, Z) of the selected interim result point M, and thereby selects the selected interim result point M as the random point R for use. The selected projective coordinates M (X, Y, Z) are input to the scalar multiplication unit 20 as the projective coordinates R (X, Y, Z) of the random point R for use. The selector 63 selects the projective coordinates Ra (X, Y, Z) of the first random point Ra, and thereby selects the first random point Ra as the random point R for use. The selected projective coordinates Ra (X, Y, Z) are input to the scalar multiplication unit 20 as the projective coordinates R (X, Y, Z) of the random point R for use.

When the scalar multiplication processing is performed for the first time after power of the processing apparatus 1 is turned on, the interim result point cannot be obtained, and thus the selector 63 selects the first random point Ra acquired based on a plurality of known points as the random point R for use to be used in the initial scalar multiplication processing. The scalar multiplication unit 20 uses the first random point Ra as the random point R for use in the initial scalar multiplication processing.

After the initial scalar multiplication processing is executed, the selector 60 selects any one of the interim result points M1 and M2 obtained in the most recent scalar multiplication processing. Then, the selector 63 selects any one of the selected interim result point M and the first random point Ra obtained in the randomizer 53 as the random point R for use to be used in the next scalar multiplication processing.

After the initial scalar multiplication processing is executed, the selector 63 may select the selected interim result point M and the first random point Ra as the random points R for use to be alternately used in the next scalar multiplication processing, for example. When the random number generator 4 stops functioning due to an external attack on the processing apparatus 1 and the randomizer 53 cannot generate the first random point Ra (for example, when the first random point Ra stops changing), the selector 63 may select the selected interim result point M as the random point R for use.

Note that three or more interim result points may be used for acquisition of the random point R for use. In this case, projective coordinates of three or more interim result points are input to the selector 60. Then, the selector 60 selects any one of the projective coordinates of the three or more interim result points and thereby selects any one of the three or more interim result points, similarly to the above-described case in which the selector 50 of FIG. 5 selects any one of x-coordinates of three or more known points and thereby selects any one of the three or more known points. In the present example as well, similarly to the example of FIG. 5, the selector 50 may select any one of three or more known points.

In this manner, the acquisition unit 25A of the present example acquires the random point R for use based on a plurality of known points and a plurality of interim result points obtained during the scalar multiplication processing, and can thus stably supply the random point R for use to the scalar multiplication unit 20.

Note that the comparator 61 may compare the y-coordinate M1 (y) of the affine coordinates M1 (x, y) obtained in the coordinate transformer 62 and the y-coordinate P (y) of the point P to be multiplied. In this case, when the comparator 61 determines that the y-coordinate M1 (y) and the y-coordinate P (y) do not match, the selector 60 selects the projective coordinates M1 (X, Y, Z) and thereby selects the interim result point M1. On the other hand, when the comparator 61 determines that the y-coordinate M1 (y) and the y-coordinate P (y) match, the selector 60 selects the projective coordinates M2 (X, Y, Z) and thereby selects the interim result point M2.

The coordinate transformer 62 may transform the projective coordinates M2 (X, Y, Z) of the interim result point M2 into affine coordinates M2 (x, y). In this case, the comparator 61 may compare the x-coordinate M2 (x) of the affine coordinates M2 (x, y) obtained in the coordinate transformer 62 and the x-coordinate P (x) of the point P to be multiplied. Then, when the comparator 61 determines that the x-coordinate M2 (x) and the x-coordinate P (x) do not match, the selector 60 selects the projective coordinates M2 (X, Y, Z) and thereby selects the interim result point M2. On the other hand, when the comparator 61 determines that the x-coordinate M2 (x) and the x-coordinate P (x) match, the selector 60 selects the projective coordinates M1 (X, Y, Z) and thereby selects the interim result point M1. The comparator 61 may compare the y-coordinate M2 (y) of the affine coordinates M2 (x, y) and the y-coordinate P (y) of the point P to be multiplied. In this case, when the comparator 61 determines that the y-coordinate M2 (y) and the y-coordinate P (y) do not match, the selector 60 selects the projective coordinates M2 (X, Y, Z) and thereby selects the interim result point M2. On the other hand, when the comparator 61 determines that the y-coordinate M2 (y) and the y-coordinate P (y) match, the selector 60 selects the projective coordinates M1 (X, Y, Z) and thereby selects the interim result point M1.

### Second Other Example

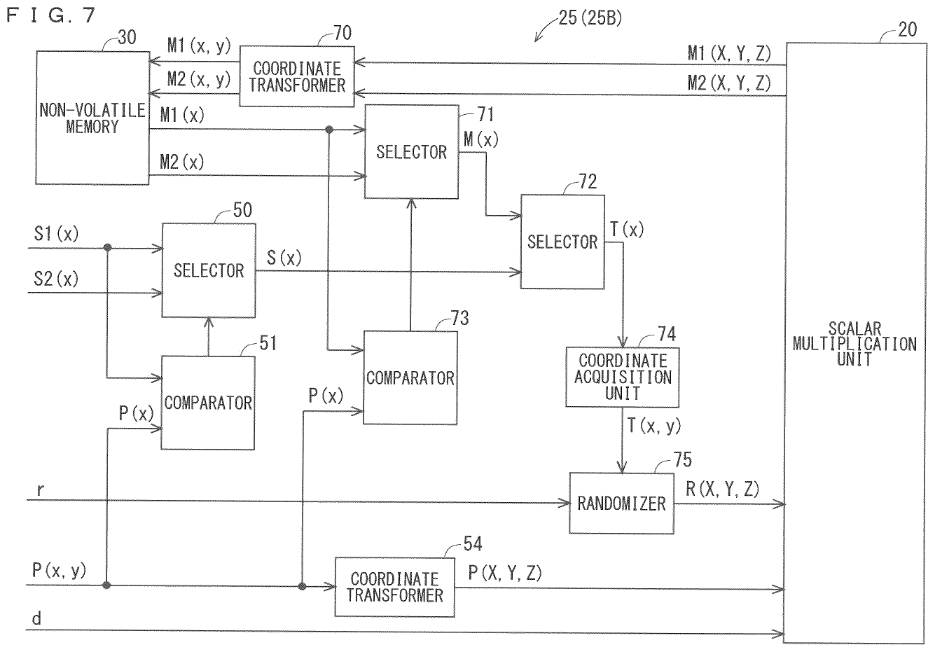

FIG. 7 is a schematic diagram illustrating another configuration example of the acquisition unit 25. The acquisition unit 25 (also referred to as an acquisition unit 25B) illustrated in FIG. 7 is different from the acquisition unit 25 illustrated in FIG. 3 in further provision of a coordinate transformer 70, a selector 71, a selector 72, and a comparator 73 and provision of a coordinate acquisition unit 74 and a randomizer 75 instead of the coordinate acquisition unit 52 and the randomizer 53.

Similarly to the acquisition unit 25A described above, the acquisition unit 25B acquires the random point R for use, based on a plurality of interim result points obtained during the scalar multiplication processing in the scalar multiplication unit 20 and a plurality of known points. For example, the acquisition unit 25B selects the known point different from the point P to be multiplied out of the plurality of known points. The acquisition unit 25B selects the known point different from the point P to be multiplied out of the known points S1 and S2, for example. The acquisition unit 25B selects the interim result point different from the point P to be multiplied out of the plurality of interim result points obtained during the scalar multiplication processing. The acquisition unit 25B selects the interim result point different from the point P to be multiplied out of the interim result points M1 and M2, for example. Then, the acquisition unit 25A acquires the random point R for use, based on the known point different from the point P to be multiplied and the interim result point different from the point P to be multiplied.

To the coordinate transformer 70, for example, the projective coordinates M1 (X, Y, Z) of the interim result point M1 and the projective coordinates M2 (X, Y, Z) of the interim result point M2 are input. The coordinate transformer 70 transforms the projective coordinates M1 (X, Y, Z) into the affine coordinates M1 (x, y), and transforms the projective coordinates M2 (X, Y, Z) into the affine coordinates M2 (x, y). The affine coordinates M1 (x, y) of the interim result point M1 and the affine coordinates M2 (x, y) of the interim result point M2 are stored in the non-volatile memory 30. This allows the non-volatile memory 30 to store the interim result points M1 and M2 together with the known points S1 and S2. Each time the scalar multiplication processing is executed, the interim result points M1 and M2 obtained in the scalar multiplication processing are overwritten and saved in the non-volatile memory 30.

To the selector 71, for example, the x-coordinate M1 (x) of the affine coordinates M1 (x, y) stored in the non-volatile memory 30 and the x-coordinate M2 (x) of the affine coordinates M2 (x, y) stored in the non-volatile memory 30 are input. The selector 71 selects any one of the x-coordinates M1 (x) and M2 (x), and thereby selects any one of the interim result points M1 and M2. When the x-coordinate M1 (x) is selected, the interim result point M1 is selected, and when the x-coordinate M2 (x) is selected, the interim result point M2 is selected.

The comparator 73 compares the x-coordinate M1 (x) of the affine coordinates M1 (x, y) stored in the non-volatile memory 30 and the x-coordinate P (x) of the point P to be multiplied, and determines whether or not the both match, for example.

When the comparator 73 determines that the x-coordinate M1 (x) of the interim result point M1 and the x-coordinate P (x) of the point P to be multiplied do not match, the selector 71 selects the x-coordinate M1 (x) and thereby selects the interim result point M1. On the other hand, when the comparator 73 determines that the x-coordinate M1 (x) of the interim result point M1 and the x-coordinate P (x) of the point P to be multiplied match, the selector 71 selects the x-coordinate M2 (x) and thereby selects the interim result point M2.

In the following, the x-coordinate selected by the selector 71 out of the x-coordinate M1 (x) and the x-coordinate M2 (x) is referred to as a selected x-coordinate M (x). In the present example, the interim result point selected by the selector 71 out of the interim result points M1 and M2 is referred to as a selected interim result point M. The selected interim result point M is different from the point P to be multiplied.

The selector 72 selects any one of the selected interim result point M and the selected known point S selected in the selector 50. The selector 72 selects any one of the selected x-coordinate S (x) selected in the selector 50 and the selected x-coordinate M (x) selected in the selector 71, and thereby selects any one of the selected interim result point M and the selected known point S, for example. The selector 72 selects the x-coordinate S (x) and thereby selects the selected known point S, and selects the x-coordinate M (x) and thereby selects the selected interim result point M.

In the following, the x-coordinate selected by the selector 72 out of the x-coordinate S (x) and the x-coordinate M (x) is referred to as a selected x-coordinate T (x). The point selected by the selector 72 out of the selected interim result point M and the selected known point S is referred to as a selected point T. The selected point T is different from the point P to be multiplied.

The coordinate acquisition unit 74 acquires affine coordinates T (x, y) of the selected point T using the selected x-coordinate T (x) and expression (1) described above, similarly to the above-described case in which the coordinate acquisition unit 52 acquires the affine coordinates S (x, y).

The randomizer 75 randomizes the coordinates of the selected point T based on the random number r generated in the random number generator 4, and acquires the random point R for multiplication use. It can also be said that the randomizer 75 acquires the random point R for multiplication use, based on the random number r and the selected point T.

The randomizer 75 transforms the affine coordinates T (x, y) of the selected point T into projective coordinates T (X, Y, Z). In this case, the randomizer 75 generates the randomized projective coordinates T (X, Y, Z), with the Z-coordinate being the random number r. In the present example, the selected point T expressed by the randomized projective coordinates T (X, Y, Z) is used as the random point R for use. The projective coordinates R (X, Y, Z) of the random point R for use match the randomized projective coordinates T (X, Y, Z).

When the selected point T is the selected known point S, the randomized projective coordinates S (X, Y, Z) of the selected known point S correspond to the randomized projective coordinates T (X, Y, Z). Thus, the random point R for use obtained in the randomizer 75 matches the first random point Ra obtained in the randomizer 53.

On the other hand, when the selected point T is the selected interim result point M, the randomized projective coordinates of the selected interim result point M correspond to the randomized projective coordinates T (X, Y, Z). Thus, the random point R for use obtained in the randomizer 75 corresponds to the selected interim result point M expressed by the randomized projective coordinates. The projective coordinates M1 (X, Y, Z) and M2 (X, Y, Z) output from the scalar multiplication unit 20 are coordinates based on the previous random number r, and thus the projective coordinates R (X, Y, Z) of the random point R for use (i.e., the randomized projective coordinates T (X, Y, Z)) are different from the projective coordinates M1 (X, Y, Z) and M2 (X, Y, Z).

When the scalar multiplication processing is performed for the first time after power of the processing apparatus 1 is turned on, the interim result point cannot be obtained, and thus the selector 72 selects the selected known point S different from the point P to be multiplied. In this case, the random point R for use used in the initial scalar multiplication processing matches the first random point Ra.

After the initial scalar multiplication processing is executed, the selector 71 selects any one of the interim result points M1 and M2 obtained in the most recent scalar multiplication processing. Then, the selector 72 selects any one of the selected interim result point M and the selected known point S selected in the selector 50. When the selector 72 selects the selected interim result point M, the random point R for use corresponds to the selected interim result point M expressed by the randomized projective coordinates. The selector 63 may alternately select the selected interim result point M and the selected known point S, for example. When the random number generator 4 stops functioning due to an external attack on the processing apparatus 1 and the random number r stops changing, the selector 72 may select the selected interim result point M. This allows for a stable supply of the random point R for use to the scalar multiplication unit 20.

Note that, in the present example as well, three or more interim result points may be used for acquisition of the random point R for use. In this case, affine coordinates of three or more interim result points are stored in the non-volatile memory 30. To the selector 71, for example, x-coordinates of the affine coordinates of the three or more interim result points stored in the non-volatile memory 30 are input. The selector 71 selects any one of the x-coordinates of the three or more interim result points, and thereby selects any one of the three or more interim result points, similarly to the selector 50 of FIG. 5 described above.

In the present example as well, similarly to the example of FIG. 5, three or more known points may be used for acquisition of the random point R for use.

In the example of FIG. 7, the selector 50 and the selector 72 select the x-coordinate of the point and thereby select the point; however, as with the selector 50 of FIG. 4 and the like, the y-coordinate of the point may be selected and the point may be thereby selected.

In this manner, in the present example, the non-volatile memory 30 stores a plurality of known points and a plurality of interim result points, and thus the acquisition unit 25B can acquire the random point R for use based on the plurality of known points and the plurality of interim result points in the non-volatile memory 30, even when the power of the processing apparatus 1 is temporarily turned off.

### Third Other Example

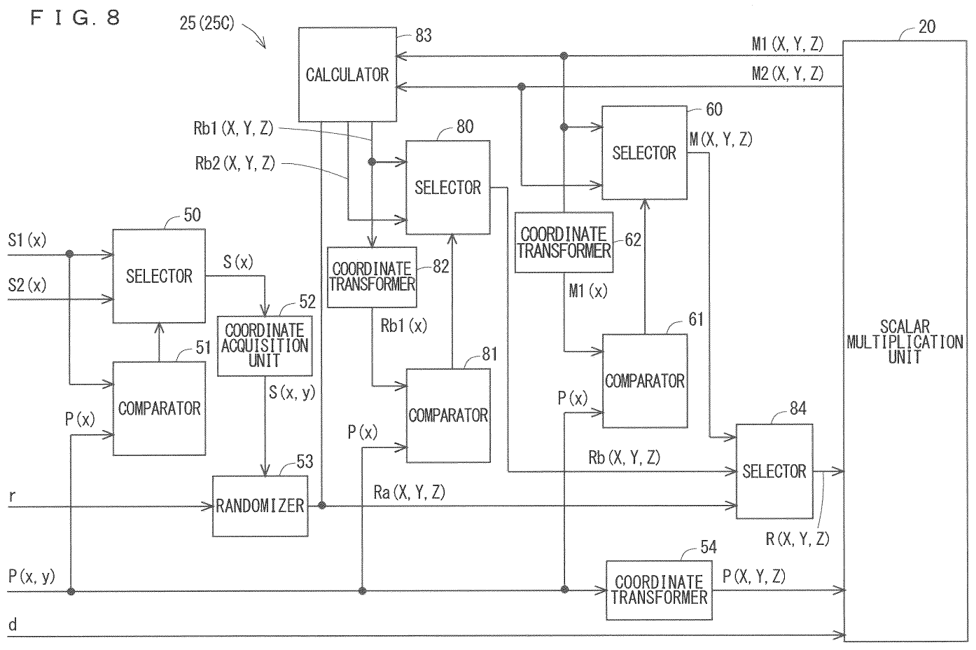

FIG. 8 is a schematic diagram illustrating another configuration example of the acquisition unit 25. The acquisition unit 25 (also referred to as an acquisition unit 25C) illustrated in FIG. 8 is different from the acquisition unit 25A illustrated in FIG. 6 in further provision of a selector 80, a comparator 81, a coordinate transformer 82, and a calculator 83 and provision of a selector 84 instead of the selector 63.

The acquisition unit 25C calculates at least a part of a plurality of interim result points obtained during the scalar multiplication processing and the first random point Ra acquired based on a plurality of known points, and acquires a plurality of second random points. Then, the acquisition unit 25C selects a second random point different from the point P to be multiplied out of the plurality of second random points. Then, the acquisition unit 25C acquires the random point R for use, based on the second random point different from the point P to be multiplied, the first random point Ra, and the interim result point different from the point P to be multiplied.

The calculator 83 calculates the interim result point and the first random point Ra obtained in the randomizer 53, and acquires the second random point different from the interim result point and the first random point Ra. For example, the calculator 83 calculates the interim result point M1 and the first random point Ra, and acquires a second random point Rb1. The calculator 83 calculates the interim result point M2 and the first random point Ra, and acquires a second random point Rb2.

The calculator 83 adds the interim result point M1 and the first random point Ra, and uses the result of addition as the second random point Rb1, for example. The calculator 83 acquires projective coordinates Rb1 (X, Y, Z) of the second random point Rb1 using the projective coordinates M1 (X, Y, Z) of the interim result point M1 and the projective coordinates Ra (X, Y, Z) of the first random point Ra, for example. Note that a method of calculating the interim result point M1 and the first random point Ra to acquire the second random point Rb1 is not limited to this.

The calculator 83 adds the interim result point M2 and the first random point Ra, and uses the result of addition as the second random point Rb2, for example. The calculator 83 acquires projective coordinates Rb2 (X, Y, Z) of the second random point Rb2 using the projective coordinates M2 (X, Y, Z) of the interim result point M2 and the projective coordinates Ra (X, Y, Z) of the first random point Ra, for example. Note that a method of calculating the interim result point M2 and the first random point Ra to acquire the second random point Rb2 is not limited to this.

The selector 80 selects any one of the second random points Rb1 and Rb2, based on the comparison result in the comparator 81. To the selector 80, the projective coordinates Rb1 (X, Y, Z) of the second random point Rb1 and the projective coordinates Rb2 (X, Y, Z) of the second random point Rb2 are input. The selector 80 selects any one of the projective coordinates Rb1 (X, Y, Z) and Rb2 (X, Y, Z), and thereby selects any one of the second random points Rb1 and Rb2. When the projective coordinates Rb1 (X, Y, Z) are selected, the second random point Rb1 is selected, and when the projective coordinates Rb2 (X, Y, Z) are selected, the second random point Rb2 is selected.

The coordinate transformer 82 transforms the projective coordinates Rb1 (X, Y, Z) of the second random point Rb1 into affine coordinates Rb1 (x, y), for example. The comparator 81 compares the x-coordinate Rb1 (x) of the affine coordinates Rb1 (x, y) obtained in the coordinate transformer 62 and the x-coordinate P (x) of the point P to be multiplied, and determines whether or not the both match.

When the comparator 81 determines that the x-coordinate Rb1 (x) of the second random point Rb1 and the x-coordinate P (x) of the point P to be multiplied do not match, the selector 80 selects the projective coordinates Rb1 (X, Y, Z) and thereby selects the second random point Rb1. On the other hand, when the comparator 81 determines that the x-coordinate Rb1 (x) and the x-coordinate P (x) match, the selector 80 selects the projective coordinates Rb2 (X, Y, Z) and thereby selects the second random point Rb2.

In the following, the projective coordinates selected by the selector 80 out of the projective coordinates Rb1 (X, Y, Z) and the projective coordinates Rb2 (X, Y, Z) are referred to as selected projective coordinates Rb (X, Y, Z). The second random point selected by the selector 80 out of the second random points Rb1 and Rb2 is referred to as a selected second random point Rb. The selected second random point Rb is different from the point P to be multiplied.

The selector 84 selects any one of the selected interim result point M selected in the selector 60, the selected second random point Rb selected in the selector 80, and the first random point Ra obtained in the randomizer 53 as the random point R for use.

To the selector 84, the selected projective coordinates M (X, Y, Z), the selected projective coordinates Rb (X, Y, Z), and the projective coordinates Ra (X, Y, Z) of the first random point Ra are input. The selector 84 selects the selected projective coordinates M (X, Y, Z), and thereby selects the selected interim result point M as the random point R for use. The selected projective coordinates M (X, Y, Z) selected by the selector 84 are input to the scalar multiplication unit 20 as the projective coordinates R (X, Y, Z) of the random point R for use. The selector 84 selects the selected projective coordinates Rb (X, Y, Z), and thereby selects the selected second random point Rb as the random point R for use. The selected projective coordinates Rb (X, Y, Z) selected by the selector 84 are input to the scalar multiplication unit 20 as the projective coordinates R (X, Y, Z) of the random point R for use. The selector 84 selects the projective coordinates Ra (X, Y, Z) of the first random point Ra, and thereby selects the first random point Ra as the random point R for use. The projective coordinates Ra (X, Y, Z) selected by the selector 84 are input to the scalar multiplication unit 20 as the projective coordinates R (X, Y, Z) of the random point R for use.

When the scalar multiplication processing is performed for the first time after power of the processing apparatus 1 is turned on, the interim result point cannot be obtained, and thus the selector 84 selects the first random point Ra acquired based on a plurality of known points as the random point R for use to be used in the initial scalar multiplication processing. The scalar multiplication unit 20 uses the first random point Ra as the random point R for use in the initial scalar multiplication processing.

After the initial scalar multiplication processing is executed, the selector 60 selects any one of the interim result points M1 and M2 (also referred to as the most recent interim result points M1 and M2) obtained in the most recent scalar multiplication processing. The calculator 83 calculates each of the most recent interim result points M1 and M2 and the first random point Ra obtained in the randomizer 53, and acquires the second random points Rb1 and Rb2. The selector 80 selects any one of the second random points Rb1 and Rb2. Then, the selector 84 selects any one of the selected interim result point M, the selected second random point Rb, and the first random point Ra as the random point R for use to be used in the next scalar multiplication processing.

After the initial scalar multiplication processing is executed, the selector 84 may sequentially select the selected interim result point M, the selected second random point Rb, and the first random point Ra as the random point R for use to be used in the next scalar multiplication processing, for example.

When the selected interim result point M is a point at infinity due to the scalar multiplier d being set to the order or greater, for example, and the selector 84 selects the selected interim result point M, a point at infinity is used as the random point R for use in the scalar multiplication processing. In this case, the countermeasure against a side-channel attack is invalidated. On the other hand, even when the interim result point M1 is a point at infinity, the second random point Rb1 obtained by calculating the interim result point M1 and the first random point Ra is less likely to be a point at infinity. Similarly, even when the interim result point M2 is a point at infinity, the second random point Rb2 obtained by calculating the interim result point M2 and the first random point Ra is less likely to be a point at infinity. Accordingly, even when the selected interim result point M is a point at infinity, the selected second random point Rb is less likely to be a point at infinity. Thus, when the selected interim result point M is a point at infinity, the selector 84 may select one of the selected second random point Rb and the first random point Ra as the random point R for use.

When the random number generator 4 stops functioning due to an external attack on the processing apparatus 1 and the randomizer 53 cannot generate the first random point Ra, the selector 84 may select one of the selected interim result point M and the selected second random point Rb as the random point R for use.

Note that, in the present example as well, three or more interim result points may be used for acquisition of the random point R for use. Here, the number of three or more interim result points used in acquisition of the random point R for use is represented by N (N is an integer of 3 or greater).

The selector 60 selects any one of N interim result points, similarly to the selector 50 of FIG. 5. The calculator 83 calculates each of the N interim result points and the first random point Ra, and acquires N second random points, for example. Then, the selector 80 selects any one of the N second random points obtained in the calculator 83.

The calculator 83 may calculate a part of the N interim result points and the first random point Ra, and acquire M (M is an integer of 2 or greater and less than N) second random points. In this case, the selector 80 selects any one of the M second random points obtained in the calculator 83.

For example, a case of N=3 is considered. In this case, the calculator 83 may calculate each of two interim result points out of three interim result points and the first random point Ra, and acquire two second random points (M=2). As another example, a case of N=4 is considered. In this case, the calculator 83 may calculate each of two or three interim result points out of four interim result points and the first random point Ra, and acquire two or three second random points (M=2 or M=3).

In the present example as well, similarly to the example of FIG. 5, three or more known points may be used for acquisition of the random point R for use.

In this manner, the acquisition unit 25C of the present example acquires the random point R for use based on a second random point different from the point P to be multiplied, the first random point Ra, and the interim result point different from the point P to be multiplied, and can thus stably supply the random point R for use to the scalar multiplication unit 20.

Note that, in the example of FIG. 8, the x-coordinate of the point is used in the selector 50, the comparator 51, the coordinate acquisition unit 52, the comparator 81, the coordinate transformer 82, and the like; however, as with the selector 50 of FIG. 4 and the like, the y-coordinate of the point may be used.

Also in the example of FIG. 8, similarly to the example of FIG. 7, the interim result points M1 and M2 may be stored in the non-volatile memory 30 together with the known points S1 and S2. In this case, for example, the projective coordinates M1 (X, Y, Z) of the interim result point M1 and the projective coordinates M2 (X, Y, Z) of the interim result point M2 may be stored in the non-volatile memory 30, and the projective coordinates M1 (X, Y, Z) and M2 (X, Y, Z) in the non-volatile memory 30 may be input to the selector 60 and the calculator 83.

The acquisition unit 25C need not include the selector 60, the comparator 61, and the coordinate transformer 62. In this case, the selector 84 selects any one of the selected second random point Rb and the first random point Ra. Such an acquisition unit 25C acquires the random point R for use, based on the second random point different from the point P to be multiplied and the first random point Ra.

In the above example, the processing apparatus 1 includes the acquisition unit 25 and the scalar multiplication unit 20, but may include only the acquisition unit 25 out of the acquisition unit 25 and the scalar multiplication unit 20. In this case, the random point R for use acquired in the processing apparatus 1 is used in another apparatus performing the scalar multiplication processing.

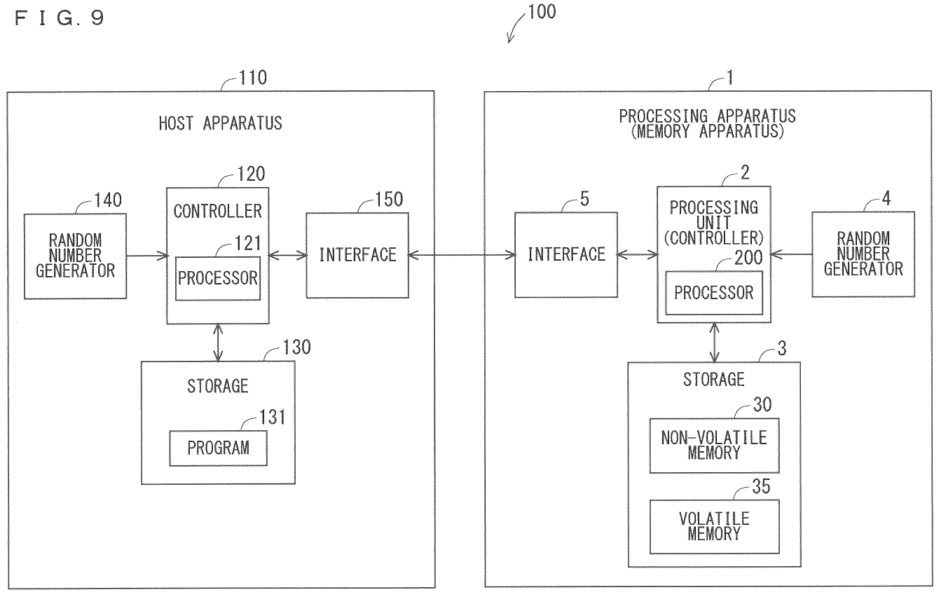

The processing apparatus 1 as described above can be used in various systems. FIG. 9 is a schematic diagram illustrating an example of a system including the processing apparatus 1. In the example of FIG. 9, the processing apparatus 1 is provided in a data processing system 100. The data processing system 100 includes a processing apparatus 1 and a host apparatus 110 that can communicate with the processing apparatus 1. It can also be said that the data processing system 100 is a communication system.

The host apparatus 110 is a higher apparatus that controls the processing apparatus 1. The host apparatus 110 integrally manages overall operations of the data processing system 100. It can be said that the host apparatus 110 is a main body apparatus of the data processing system 100.

The data processing system 100 may be a portable electronic device, such as a smartphone or a tablet, or may be another system, for example. When the data processing system 100 is a portable electronic device, the host apparatus 110 functions as a portable electronic device main body.

In the data processing system 100, the processing apparatus 1 functions as a memory apparatus, for example. The host apparatus 110 can read data from the processing apparatus 1 serving as the memory apparatus, and write data in the processing apparatus 1. For example, when the host apparatus 110 gives a reading instruction regarding data to the processing apparatus 1, the processing apparatus 1 reads the data in the non-volatile memory 30 and outputs the data to the host apparatus 110. When the host apparatus 110 gives a writing instruction regarding data to the processing apparatus 1, the processing apparatus 1 writes data from the host apparatus 110 in the non-volatile memory 30. The non-volatile memory 30 is also referred to as a memory core, for example.

The host apparatus 110 includes a controller 120, a storage 130, a random number generator 140, and an interface 150, for example. It can also be said that the host apparatus 110 is a computer apparatus, for example.

The random number generator 140 generates a random number, similarly to the random number generator 4 included in the processing apparatus 1. The interface 150 can directly communicate with an interface 5 to be described later included in the processing apparatus 1. It can also be said that the interface 150 is an interface circuit, for example. It can also be said that the interface 150 is a communication unit or a communication circuit, for example. The interface 150 may perform wired communication or wireless communication with the interface 5.

The controller 120 can integrally manage the operations of the host apparatus 110 by controlling other constituent elements of the host apparatus 110. It can also be said that the controller 120 is a control circuit, for example. The controller 120 includes at least one processor 121, for example. The at least one processor 121 included in the controller 120 may include a CPU, for example.

The controller 120 can give a writing instruction and a reading instruction to the processing apparatus 1 via the interface 150. The controller 120 can generate data to be written in the processing apparatus 1, and cause the interface 150 to transmit the generated data. The controller 120 can acquire, via the interface 150, data that is output by the processing apparatus 1 having received the reading instruction. The controller 120 performs processing using the data that the interface 150 receives from the processing apparatus 1.

The storage 130 includes a non-volatile memory and a volatile memory, for example. It can also be said that the non-volatile memory and the volatile memory are each a non-transitory recording medium that can be read by the CPU of the controller 120. The non-volatile memory may be a flash memory, for example. The non-volatile memory may be a NAND flash memory, for example. The volatile memory functions as a working memory or the like when the controller 120 performs data processing. The volatile memory may include an SRAM, or may include a DRAM.

The non-volatile memory stores a program 131 and the like defining operations of the controller 120. Various functions of the controller 120 are implemented when the CPU of the controller 120 executes the program 131, for example.

Note that the configuration of the controller 120 is not limited to the above example. For example, the at least one processor 121 included in the controller 120 may include a plurality of CPUs, or may include at least one DSP. All of the functions of the controller 120 or a part of the functions of the controller 120 may be implemented by a hardware circuit that does not require software for implementing its functions. The storage 130 may include a small-sized hard disk drive, an SSD, or the like.

The host apparatus 110 may include a display unit, such as a liquid crystal display. In this case, the host apparatus 110 may cause the display unit to display data read from the processing apparatus 1. The host apparatus 110 may include an input unit that receives a user input. The input unit may include a mouse and a keyboard, may include a touch sensor that detects a touch operation of a user, or may include a microphone that receives a voice input of a user, for example.

In the example of FIG. 9, the processing apparatus 1 includes the interface 5 that communicates with the host apparatus 110, for example, other than the processing unit 2, the storage 3, and the random number generator 4. It can also be said that the interface 5 is an interface circuit, for example. It can also be said that the interface 5 is a communication unit or a communication circuit, for example.

The processing unit 2 controls other configurations of the processing apparatus 1, and thereby functions as a controller that integrally manages operations of the processing apparatus 1. In the present example, the processing unit 2 may be referred to as the controller 2. It can also be said that the controller 2 is a control circuit, for example. The controller 2 can control the interface 5, and can control the non-volatile memory 30 and the volatile memory 35 of the storage 3. It can also be said that the controller 2 is a memory controller.

When the controller 2 receives a reading instruction from the host apparatus 110 via the interface 5, the controller 2 reads data from the non-volatile memory 30. Then, the controller 2 causes the interface 5 to transmit the read data. When the controller 2 receives a writing instruction and data from the host apparatus 110 via the interface 5, the controller 2 writes the received data in the non-volatile memory 30.

The controller 2 of the processing apparatus 1 performs processing using the scalar multiplication point dP obtained in the scalar multiplication unit 20. The processing apparatus 1 performs encrypted communication based on common key cryptography, for example, with the host apparatus 110. The processing apparatus 1 performs key exchange processing with the host apparatus 110, where a common key used in the encrypted communication is exchanged. The processing apparatus 1 uses the scalar multiplier d and the scalar multiplication point dP in the key exchange processing with the host apparatus 110.

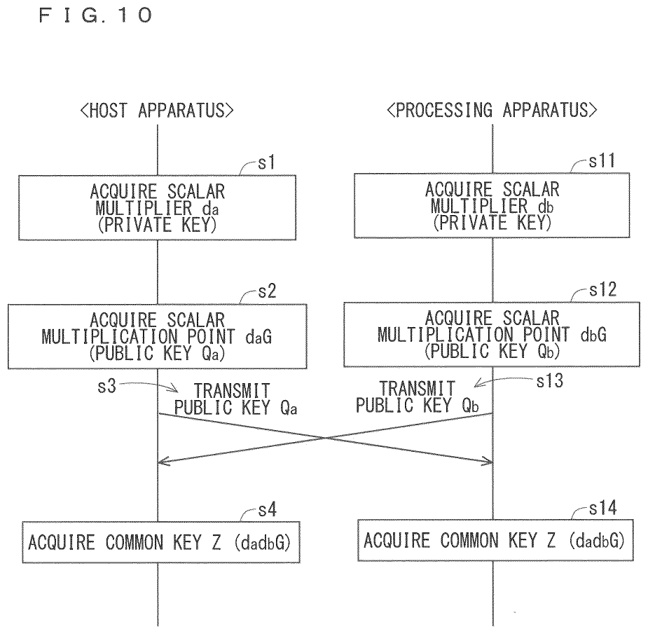

FIG. 10 is a schematic diagram illustrating an example of the key exchange processing between the processing apparatus 1 and the host apparatus 110. The controller 120 of the host apparatus 110 includes, as its functional blocks, an acquisition unit and a scalar multiplication unit similar to the acquisition unit 25 and the scalar multiplication unit 20 included in the processing apparatus 1, for example. The controller 120 acquires the scalar multiplication point using the same elliptic curve as the elliptic curve for use used by the controller 2.

In the key exchange processing, in step s1, the controller 120 of the host apparatus 110 acquires a scalar multiplier dₐ as a private key, based on a random number generated in the random number generator 140, for example. Next, in step s2, with the base point G used in the key exchange processing being used as the point to be multiplied, the controller 120 multiplies the base point G by the scalar multiplier dₐ, and acquires a scalar multiplication point dₐG as a public key Qₐ. Then, in step s3, the controller 120 transmits the acquired public key Qₐ (i.e., the scalar multiplication point dₐG) to the processing apparatus 1 via the interface 150. The public key Qₐ is a point on the elliptic curve for use used by the controller 120.

On the other hand, in step s11, the controller 2 of the processing apparatus 1 acquires a scalar multiplier d (herein referred to as a scalar multiplier d_{b}) as a private key, based on the random number r generated in the random number generator 4, for example. Next, in step s12, with the base point G used in the key exchange processing being used as the point P to be multiplied, the controller 2 multiplies the base point G by the scalar multiplier d_{b}, and acquires a scalar multiplication point d_{b}G as a public key Q_{b}. The base point G is shared between the host apparatus 110 and the processing apparatus 1. Then, in step s13, the controller 2 transmits the acquired public key Q_{b} (i.e., the scalar multiplication point d_{b}G) to the host apparatus 110 via the interface 5. The public key Q_{b} is a point on the elliptic curve for use used by the controller 2.

In the host apparatus 110 that has received the public key Q_{b}, in step s4, with the public key Q_{b} being used as the point to be multiplied, the controller 120 multiplies the public key Q_{b} by the scalar multiplier dₐ, and acquires a scalar multiplication point Q_{b}dₐ as a common key Z. The common key Z is represented by dₐd_{b}G.

On the other hand, in the processing apparatus 1 that has received the public key Qₐ, in step s14, with the public key Qₐ being used as the point P to be multiplied, the controller 2 multiplies the public key Qₐ by the scalar multiplier d_{b}, and acquires a scalar multiplication point Qₐd_{b} (i.e., dₐd_{b}G) as the common key Z.

As described above, the key exchange processing is executed between the host apparatus 110 and the processing apparatus 1, and the common key Z is exchanged between the host apparatus 110 and the processing apparatus 1. In the host apparatus 110, the controller 120 encrypts data to be transmitted to the processing apparatus 1 with the common key Z, and transmits the resulting encrypted data to the processing apparatus 1 via the interface 150. In the processing apparatus 1 that has received the encrypted data, the controller 2 decrypts the encrypted data with the common key Z, and acquires plaintext data. Then, the controller 2 writes the acquired plaintext data in the non-volatile memory 30, for example. On the other hand, in the processing apparatus 1, the controller 2 encrypts data read from the non-volatile memory 30 with the common key Z, and transmits the resulting encrypted data to the host apparatus 110 via the interface 5. In the host apparatus 110 that has received the encrypted data, the controller 120 decrypts the encrypted data with the common key Z, and acquires plaintext data. Then, the controller 120 performs processing using the acquired plaintext data.

When the controller 2 of the processing apparatus 1 transmits data to the host apparatus 110, the controller 2 may add an electronic signature generated based on the scalar multiplier d and the scalar multiplication point dP to the data. The controller 120 of the host apparatus 110 that has received the data with the electronic signature verifies the electronic signature. When the controller 120 of the host apparatus 110 transmits data to the processing apparatus 1, the controller 120 may add an electronic signature generated based on the scalar multiplier and the scalar multiplication point to the data. The controller 2 of the processing apparatus 1 that has received the data with the electronic signature verifies the electronic signature.

The functionality of the elements disclosed herein may be implemented using circuitry or processing circuitry which includes general purpose processors, special purpose processors, integrated circuits, ASICs (“Application Specific Integrated Circuits”), conventional circuitry and/or combinations thereof which are configured or programmed to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

As described above, while the processing apparatus has been described in detail, the foregoing description is in all aspects illustrative, and the present invention is not limited thereto. Various examples described above can be applied in combination, on the condition that the combination is consistent. It is therefore understood that numerous unillustrated examples can be devised without departing from the scope of the present disclosure.

The present disclosure includes the following aspects.

A processing apparatus according to a first aspect includes an acquisition unit configured to acquire a random point for use different from a point to be multiplied on an elliptic curve defined in a finite field, based on a plurality of first points known to be located on the elliptic curve, the random point for use being used to randomize the point to be multiplied in scalar multiplication processing of multiplying the point to be multiplied by a scalar multiplier.

A processing apparatus according to a second aspect is the processing apparatus according to the first aspect. The acquisition unit selects a first point different from the point to be multiplied out of the plurality of first points. The acquisition unit acquires the random point for use, based on the first point different from the point to be multiplied.

A processing apparatus according to a third aspect is the processing apparatus according to the second aspect. The acquisition unit compares a first coordinate of one first point on one axis included in the plurality of first points and a second coordinate of the point to be multiplied on the one axis, and when the first coordinate and the second coordinate are different, selects the one first point as the first point different from the point to be multiplied.

A processing apparatus according to a fourth aspect is the processing apparatus according to the third aspect. When the first coordinate and the second coordinate match, the acquisition unit selects a first point different from the one first point out of the plurality of first points as the first point different from the point to be multiplied.

A processing apparatus according to a fifth aspect is the processing apparatus according to any one of the first to fourth aspects. The plurality of first points include a point having a smallest coordinate on one axis and a point having a second smallest coordinate on the one axis out of a finite number of points on the elliptic curve defined in the finite field.

A processing apparatus according to a sixth aspect is the processing apparatus according to any one of the first to fifth aspects. The acquisition unit acquires the random point for use, based on the plurality of first points and a plurality of interim result points obtained during the scalar multiplication processing.

A processing apparatus according to a seventh aspect is the processing apparatus according to the sixth aspect. The acquisition unit selects a first point different from the point to be multiplied out of the plurality of first points. The acquisition unit selects an interim result point different from the point to be multiplied out of the plurality of interim result points. The acquisition unit acquires the random point for use, based on the first point different from the point to be multiplied and the interim result point different from the point to be multiplied.

A processing apparatus according to an eighth aspect is the processing apparatus according to the sixth aspect. The acquisition unit acquires a first random point different from the point to be multiplied, based on the first point different from the point to be multiplied. The acquisition unit calculates at least a part of the plurality of interim result points and the first random point, so that the circuitry acquires a plurality of second random points. The acquisition unit selects a second random point different from the point to be multiplied out of the plurality of second random points. The acquisition unit acquires the random point for use, based on the second random point different from the point to be multiplied and the first random point.

A processing apparatus according to a ninth aspect is the processing apparatus according to the eighth aspect. The acquisition unit selects an interim result point different from the point to be multiplied out of the plurality of interim result points. The acquisition unit acquires the random point for use, based on the second random point different from the point to be multiplied, the first random point, and the interim result point different from the point to be multiplied.

A processing apparatus according to a tenth aspect is the processing apparatus according to any one of the sixth to ninth aspects. The processing apparatus further includes a non-volatile memory configured to store the plurality of first points and the plurality of interim result points.

A processing apparatus according to an eleventh aspect is the processing apparatus according to any one of the first to tenth aspects. The processing apparatus further includes a scalar multiplication unit configured to perform the scalar multiplication processing.

A processing apparatus according to a twelfth aspect is the processing apparatus according to the eleventh aspect. The processing apparatus further includes a non-volatile memory, and a controller configured to control the non-volatile memory, the controller including the acquisition unit and the scalar multiplication unit. The controller performs processing using a result of multiplication of the point to be multiplied by the scalar multiplier, the result of multiplication being obtained in the scalar multiplication unit.

An acquisition method according to a thirteenth aspect is an acquisition method used in an apparatus. The acquisition method includes acquiring a random point for use different from a point to be multiplied on an elliptic curve defined in a finite field, based on a plurality of first points known to be located on the elliptic curve, the random point for use being used to randomize the point to be multiplied in scalar multiplication processing of multiplying the point to be multiplied by a scalar multiplier.

A program according to a fourteenth aspect is a program configured to cause a computer apparatus to function as the acquisition unit included in the processing apparatus according to any one of the first to tenth aspects.

While the disclosure has been shown and described in detail, the foregoing description is in all aspects illustrative and not restrictive. It is therefore understood that numerous modifications and variations can be devised.

What is claimed is:

1. A processing apparatus comprising
circuitry configured to acquire a random point for use different from a point to be multiplied on an elliptic curve defined in a finite field, based on a plurality of first points known to be located on the elliptic curve, the random point for use being used to randomize the point to be multiplied in scalar multiplication processing of multiplying the point to be multiplied by a scalar multiplier.

2. The processing apparatus according to claim 1, wherein
the circuitry selects a first point different from the point to be multiplied out of the plurality of first points, and
the circuitry acquires the random point for use, based on the first point different from the point to be multiplied.

3. The processing apparatus according to claim 2, wherein
the circuitry compares a first coordinate of one first point on one axis included in the plurality of first points and a second coordinate of the point to be multiplied on the one axis, and when the first coordinate and the second coordinate are different, selects the one first point as the first point different from the point to be multiplied.

4. The processing apparatus according to claim 3, wherein
when the first coordinate and the second coordinate match, the circuitry selects a first point different from the one first point out of the plurality of first points as the first point different from the point to be multiplied.

5. The processing apparatus according to claim 1, wherein
the plurality of first points include a point having a smallest coordinate on one axis and a point having a second smallest coordinate on the one axis out of a finite number of points on the elliptic curve defined in the finite field.

6. The processing apparatus according to claim 1, wherein
the circuitry acquires the random point for use, based on the plurality of first points and a plurality of interim result points obtained during the scalar multiplication processing.

7. The processing apparatus according to claim 6, wherein
the circuitry selects a first point different from the point to be multiplied out of the plurality of first points, and
the circuitry selects an interim result point different from the point to be multiplied out of the plurality of interim result points, and
the circuitry acquires the random point for use, based on the first point different from the point to be multiplied and the interim result point different from the point to be multiplied.

8. The processing apparatus according to claim 6, wherein
the circuitry acquires a first random point different from the point to be multiplied, based on the first point different from the point to be multiplied,
the circuitry calculates at least a part of the plurality of interim result points and the first random point, so that the circuitry acquires a plurality of second random points,
the circuitry selects a second random point different from the point to be multiplied out of the plurality of second random points, and
the circuitry acquires the random point for use, based on the second random point different from the point to be multiplied and the first random point.

9. The processing apparatus according to claim 8, wherein
the circuitry selects an interim result point different from the point to be multiplied out of the plurality of interim result points, and
the circuitry acquires the random point for use, based on the second random point different from the point to be multiplied, the first random point, and the interim result point different from the point to be multiplied.

10. The processing apparatus according to claim 6, further comprising
a non-volatile memory configured to store the plurality of first points and the plurality of interim result points.

11. The processing apparatus according to claim 1, wherein
the circuitry performs the scalar multiplication processing.

12. The processing apparatus according to claim 11, further comprising
a non-volatile memory configured to be controlled by the circuitry, wherein
the circuitry performs processing using a result of multiplication of the point to be multiplied by the scalar multiplier.

13. An acquisition method comprising
acquiring a random point for use different from a point to be multiplied on an elliptic curve defined in a finite field, based on a plurality of first points known to be located on the elliptic curve, the random point for use being used to randomize the point to be multiplied in scalar multiplication processing of multiplying the point to be multiplied by a scalar multiplier.

14. A non-transitory computer-readable recording medium configured to store a program to cause a computer apparatus to function as the circuitry comprised in the processing apparatus according to claim 1.
